(19) United States
(12) Patent Application Publication
(10) Pub. No.: US 2006/0227530 A1
(43) Pub. Date: Oct. 12, 2006

(54) Decoration connected with ELY

(76) Inventor: Wan-Chu Wang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/102,683

(22) Filed: Apr. 11, 2005

(51) Int. Cl. F21V 9/16

(52) U.S. Cl. 362/84

(57) ABSTRACT

The invention relates to a patterned decoration connected with ELY (electro luminescent wire), which includes a patterned decoration and ELY being connected around the circumstance. The ELY can be lightened by either DC or AC without any tungsten bulb or LED provided. Hence, the ELY decoration can provides better decorative effect showing the special obvious outlook whenever at day or at night.

### FIELD OF THE INVENTION

The present invention relates to a patterned decoration, which connects with ELY, i.e. electro luminescent wires, around to display its special decorative effect.

### BACKGROUND OF THE INVENTION

In holidays, people usually utilize many different patterned decorations for celebration. At night, light strings and lamps are used to show the decorative purpose. The conventional patterned decoration is not visual at night and the conventional light string is not patterned but randomly located. This kind of decoration should be improved.

### SUMMARY OF THE INVENTION

The present invention is to provide an invented design, which includes a patterned decoration connected with ELY alone its circumstance, wherein the ELY means an electro luminescent wire, which can be lightened by either DC or AC without any tungsten bulb or LED provided. The assembled decoration can provide the special decorative effect whenever at day or night. Now, accompanying with the following drawings, the character of the present invention will be described here and after.

### BRIEF DESCRIPTION OF THE DRAWINGS

FIG. 1 is an assembled plan view showing an embodiment of a patterned decoration connected with ELY according to the present invention.

FIG. 2 is an assembled plan view showing another embodiment of a patterned decoration connected with ELY according to the present invention.

FIG. 3 is an assembled plan view showing a further embodiment of a patterned decoration connected with ELY according to the present invention.

FIG. 4 is an enlarged view showing a part of FIG. 1.

FIG. 5 is an enlarged view showing a part of FIG. 2.

FIG. 6 is an enlarged view showing a part of FIG. 3.

### DETAILED DESCRIPTION OF THE PREFERRED EMBODIMENT

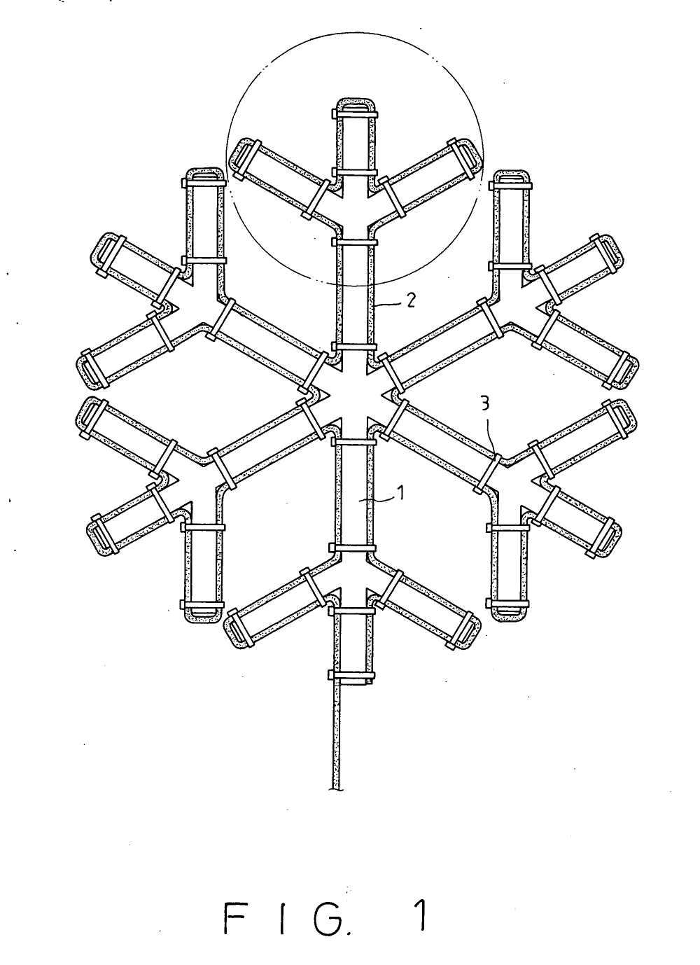

Please refer to FIG. 1, this invention mainly relates to an ELY decoration, which includes a basic patterned decoration (1), for example a hexagonal structure in the drawing. It is known that any other structure is available and the ELY is an electro luminescent wire, which can be lightened by either DC or AC without any tungsten bulb or LED provided.

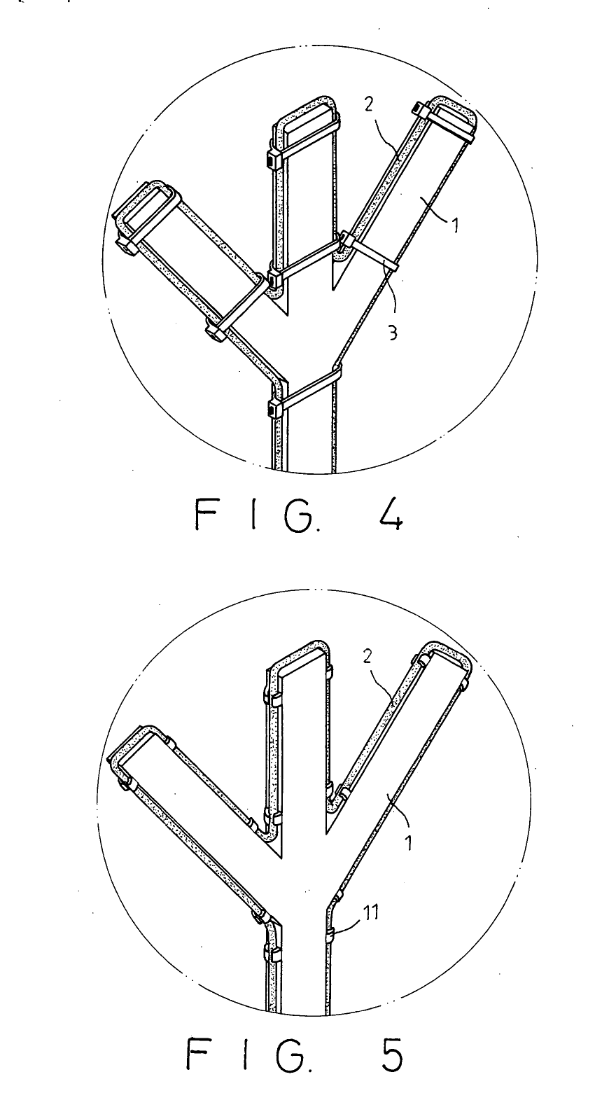

The improvement of the present invention is to provide a patterned decoration (1) connected with ELY (2) around the circumstance of the body. Referring to FIG. 4, it shows an embodiment that the ELY (2) is firmly connected with the decoration (1) by loops (3). Hence, the ELY (2) has the same outlook as the patterned decoration (1). It is to be understood that the present invention can display its special decorative effect whenever at day by the decoration itself or at night by the lighting ELY.

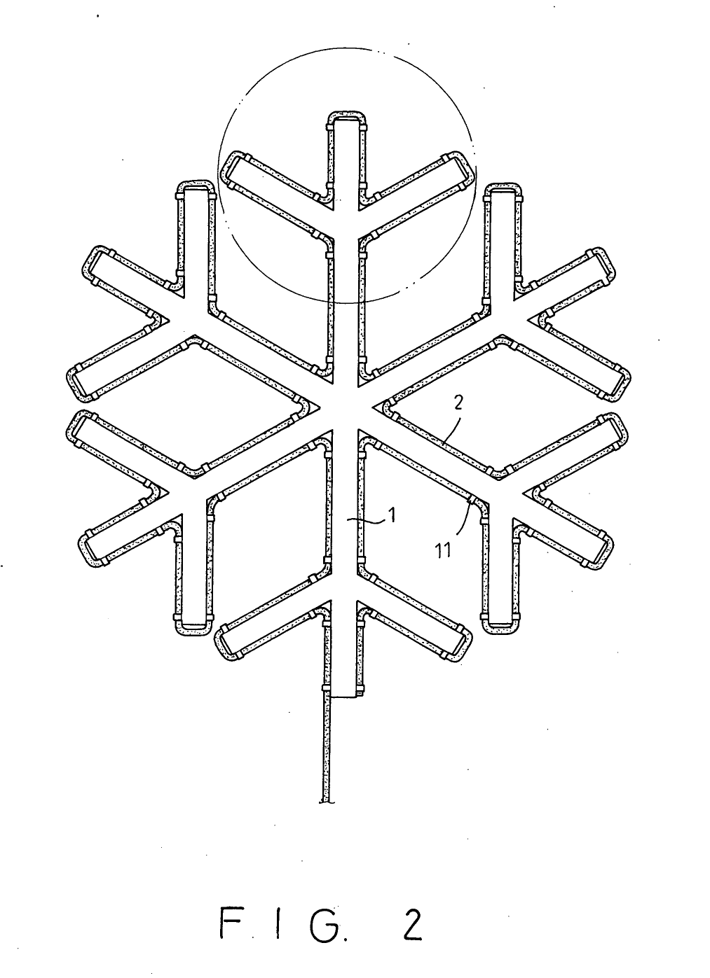

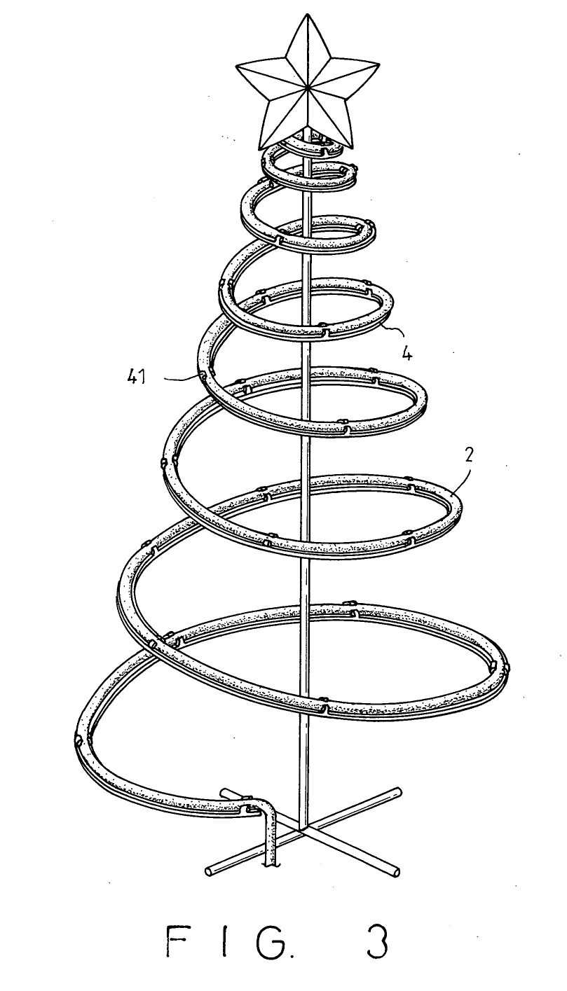

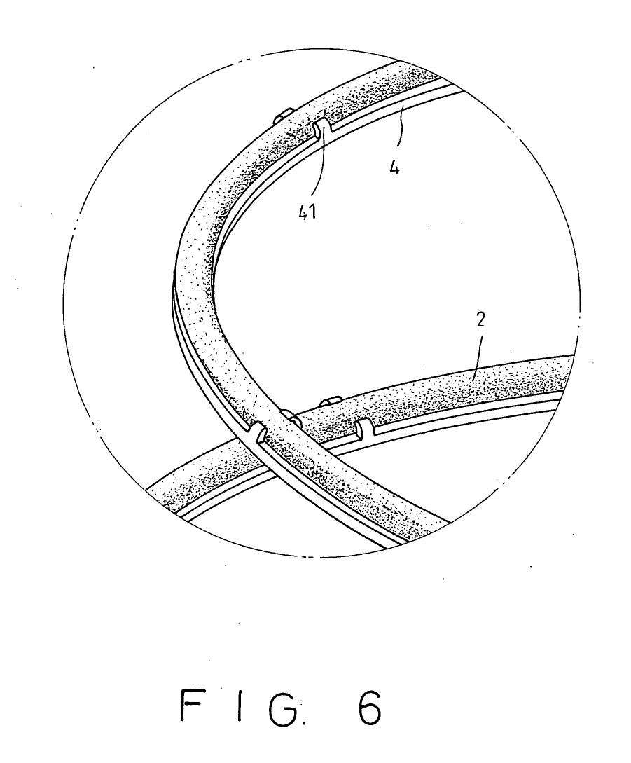

Please refer to FIGS. 2 and 5, it shows another embodiment of the present invention that the ELY (2) is connected with the decoration (1) by engaged hooks (11) provided on the decoration (1). It can obtain the same decorative effect as said structure. FIGS. 3 and 6 shows an embodiment that includes a different patterned decoration being an annual ring (4). The ring (4) is provided with several hooks (41) to connect with the ELY thereon directly that can shows the special decorative effect according to the present invention.

Accordingly, the present invention is obviously utilized and effective. It should be allowed for patent.

I claim:

1. A patterned decoration connected with ELY (electro luminescent wire) including a patterned decoration and the ELY being connected with the decoration around the circumstance of the body while the ELY having the same outlook as the decoration firmly.

2. A patterned decoration connected with ELY as claimed in claim 1, wherein the ELY is connected with the decoration by loops.

3. A patterned decoration connected with ELY as claimed in claim 1, wherein the ELY is connected with the decoration by hooks formed on the decoration.

4. A patterned decoration connected with ELY as claimed in claim 1, wherein the ELY is lightened to show an outlook being the same as the decoration.
